(19) United States
(12) Patent Application Publication
(10) Pub. No.: US 2026/0257169 A1
(43) Pub. Date: Sep. 3, 2026

(54) METHOD, DEVICE AND SYSTEM FOR DESTROYING ONE OR MORE POLLUTANT

(71) Applicant: TREATA ENVIRONMENTAL PTY LTD, Balwyn North, Victoria (AU)

(72) Inventors: Victor Rudolph, Balwyn North, Victoria (AU); Pradeep R. Shukla, Balwyn North, Victoria (AU)

(21) Appl. No.: 18/994,688

(22) PCT Filed: Jul. 19, 2023
(86) PCT No.: PCT/AU2023/050663

§ 371 Date: Jan. 15, 2025

(30) Foreign Application Priority Data
Jul. 19, 2022 (AU) 2022902019

(51) Int. Cl. B01D 53/32

(52) U.S. Cl. CPC B01D 53/326; B01D 2257/2066; B01D 2259/818

(57) ABSTRACT

A method for destruction of one or more pollutant comprising creating an arc between a cathode and an anode with a dual feed plasma device comprising a primary gas and a secondary gas comprising the one or more pollutant is described. Also described are a dual feed plasma device and a system for pollutant destruction comprising a primary gas line and a secondary gas line and the dual feed plasma device which creates an arc between a cathode and an anode, the dual feed comprising the primary gas and the secondary gas. The primary gas may comprise a condensable gas, for example steam, optionally, a high temperature superheated steam or optionally a mixture of high temperature steam and hydrogen peroxide. The secondary gas may comprise one or more of air; argon; or a mist of the one or more pollutant.

### FIELD OF THE INVENTION

A method, apparatus and system to break down waste fluoro-organic chemicals such as, PFAS (per fluoro alkyl substances) or mixture of PFAS with organic chemicals in a liquid mixture. Advantageously, all the chemicals targeted for break down are destroyed and the resulting reaction end products that are non-toxic is described. The method, apparatus and system may be used for destroying the chemical may comprise a dual feed injection thermal plasma device. The plasma device may comprise a cathode and an anode between which an arc is generated. A plasma forming gas may be injected in the primary feed line between the electrodes while a secondary feed may be injected into the anode chamber. The plasma forming gas may comprise oxygen or hydrogen or both combined. The plasma forming gas may also comprise of vapour that has been generated from boiling water. The waste liquid may be dosed into the secondary feed line which injects the pollutant into the anode chamber at high injection velocity to mix the waste chemical with the plasma ions to breakdown and destroy the waste chemicals. The reaction end product and the plasma gas may be quenched and neutralised using alkaline scrubbing.

### BACKGROUND TO THE INVENTION

There are numerous thermochemical technologies that have been developed for the destruction of fluorinated and chlorinated chemicals. Thermal electric arc plasmas have been at the forefront among several technologies to destroy highly recalcitrant and toxic compounds, offering complete destruction in milliseconds. At an arc temperature greater than 10,000 deg C. and average plasma plume temperature greater than 3,000 deg C., and in presence of excess oxygen, the majority of organic chemicals can be decomposed and converted to the stable oxidised form.

The plasma destruction process involves generating an electrical arc between two electrodes while a gas is fed between the electrodes that ionises the gas to generate the plasma. The pollutant stream is injected into this plasma gas stream via the secondary feeding line whereby the chemicals are immediately broken down into elements. As the plasma plume moves away from the electric arc, it gives back energy to undergo self-quenching, wherein the unstable reaction intermediates recombine to form stable end products. The reaction quenching rate is controlled to by spraying cold fluid to suppress the formation of any unwanted toxic end products such as dioxins or fluorocarbons.

Thermal plasma torches are commonly operated using argon gas due to the inherent arc stability, although nitrogen and air plasma is equally popular and beneficial. The thermal destruction of chlorinated pollutants using air plasma has drawbacks due to higher potential of dioxins and furan production in comparison to the argon or nitrogen plasma. However, the oxygen free plasma gasification process, such as nitrogen plasma requires a nitrogen production plant or argon supply alongside the thermal destruction plant. The gasification of waste products can provide a useful fuel source such as hydrogen and CO, however the variability of the feed source and partial destruction of toxic chemical is a major risk for such a technology.

U.S. Pat. No. 6,987,792 B2 assigned to the Solena group, Inc describes a process of plasma gasification of solid and liquid organic materials and in turn generates electrical energy using the syn-gas produced from the waste pyrolysis. The plasma torch is operated with a controlled amount of oxygen enriched air to facilitate the effective gasification.

U.S. Pat. No. 4,644,877 describes the plasma destruction of toxic and hazardous chemicals such as polychlorinated biphenyls. These chlorinated chemicals were destroyed using a 200 to 500 kW air plasma device that provides a semi oxidising environment within the plasma reactor. Since the quantity of oxygen fed into the system was stoichiometrically lower than the theoretical air required for the plasma torch the process was considered to be pyrolytic. The process was equipped with a product gas analyser to alert the process if any unwanted gaseous product was emitted from the process. The product gas was quenched and neutralised in an alkaline scrubber before releasing to a flare.

WO2008136011A1, filed by the Institute of plasma research, discloses their plasma technology for medical waste and hazardous waste destruction. The plasma torch consisted of graphite electrode and is operated using nitrogen as the plasma gas. The plasma torch consisted of 2 cathodes with their tips facing each other and an anode perpendicular to the axis of cathode. The waste pyrolysis was carried out in two stages and in an oxygen starved environment. The pyrolysed product in the first stage of thermal treatment containing CO₂, H₂ and hydrocarbons were transferred to a secondary chamber where they were burned to end products which were then sent to an alkaline neutralising unit.

U.S. Pat. No. 6,971,323B2 assigned to PEAT International, Inc, teaches a method of destruction of toxic waste including medical waste using an AC plasma torch with a variable flame. The process also operated under lean oxygen phase to facilitate gasification followed by secondary oxidation.

U.S. Pat. No. 5,090,340 discloses the method of plasma disintegration of waste material. The plasma torch is operated with air or nitrogen as the plasma gas.

There are several commercial processes which currently use a thermal plasma system for destruction of hazardous chemicals. As an example, the Plascon technology developed by CSIRO and currently owned by CleanAway Technology Australia, uses a 150 KW argon based plasma torch consisting of a rod shaped cathode with a sharp tip facing the a coxial anode which is spaced at a pre-determined distance by putting water cooled spacers in between. The waste liquid (for example, polychlorinated biphenyl (PCB)) is injected together with air into the plasma plume. The reaction products are rapidly quenched with cold water followed by neutralising the product gases with alkaline solution.

Similarly, a transportable plasma destruction unit was developed by Westinghouse for destruction of PCB's, CCl₄ etc. The process utilizes a semi-gasification technology where the pyrolysis reaction is conducted in lean oxygen environment. The electric arc hangs between the co-axial cathode and anode and swirls around the inner circumference of the electrodes by an aid of electromagnetic stabilization device. The technology claims to provide high destruction efficiency of greater than 99.999%.

The reference to any prior art in this specification is not, and should not be taken as, an acknowledgement or any form of suggestion that the prior art forms part of the common general knowledge.

### SUMMARY OF THE INVENTION

A method, apparatus and system to break down waste fluoro-organic chemicals such as, PFAS (per fluoro alkyl substances) or mixture of PFAS with organic chemicals in a liquid mixture is described. Advantageously, in one embodiment, all or substantially all the chemicals targeted for break down may be destroyed and the resulting reaction end products may be non-toxic.

A method, apparatus and system for destroying PFAS (perfluorinated fluoroalkyl substances) concentrates and other contaminated waste containing PFAS together with other fluorinated and chlorinated organic chemicals or a mixture of PFAS contaminated liquid and gaseous steam with other organic chemicals is described.

In one embodiment, the destruction is by reacting the chemicals with high temperature plasma gas, whereby the plasma gas provides the heat and necessary reactants to convert the fluorine and chlorine in the organic chemicals into an acidic gas such as hydrogen fluoride and hydrogen chloride respectively.

In one embodiment the pollutant is fed directly into the plasma anode chamber to facilitate inflight ionization to completely breakdown the pollutant molecule.

In one aspect, although it need not be the only or indeed the broadest form, the invention provides a method for destruction of one or more pollutant, the method comprising:

creating an arc between a cathode and an anode with a dual feed plasma device, the dual feed comprising a primary gas and a secondary gas, the secondary gas comprising the one or more pollutant for destruction.

The method of the first aspect may further comprise recirculating high pressure hot water around an external surface of the anode and optionally the cathode.

The method of the first aspect may further comprise receiving said plasma jet for further transformation of ionised products.

In a second aspect the invention provides a plasma device for destruction of one or more pollutant, the plasma device comprising:

a dual feed plasma device comprising a cathode and an anode, the dual feed comprising a primary gas and a secondary gas, the secondary gas comprising the one or more pollutant for destruction.

The device of the second aspect may comprise a hot water recirculatory tom provide high pressure hot water recirculation around the anode and optionally the cathode.

The device of the second aspect may comprise a reaction vessel into which is received said plasma jet for further transformation of ionised products.

In a third aspect the invention provides a system for pollutant destruction comprising:
a primary gas line providing a primary gas;
a secondary gas line providing a secondary gas; and
a dual feed plasma device which creates an arc between a cathode and an anode, the dual feed comprising the primary gas and the secondary gas, the secondary gas comprising the one or more pollutant for destruction.

In one embodiment of the third aspect, a hot water recirculator may provide high pressure hot water recirculation around the anode and optionally the cathode.

In another embodiment of the third aspect, the system may comprise a reactor vessel for receiving said plasma jet for further transformation of ionised products.

According to any one of the above aspects, the one or more pollutant comprises waste fluoro-organic chemicals such as, PFAS. The PFAS may comprise PFAS or mixture of PFAS with organic chemicals. The PFAS may be in a liquid mixture.

The plasma device according to any one of the above aspects may comprise a power supply.

According to any one of the above aspects, the plasma device may comprise a rod shaped 2% thoriated tungsten cathode and a hollow cylindrical zero oxygen-copper anode.

According to any one of the above aspects, the water may comprise recirculated hot water and may optionally maintain the temperature of the anode wall at 120 deg C. or more.

According to any one of the above aspects, an average interior temperature in the plasma device reactor vessel is 1,200° C.

According to any one of the above aspects a surface wall temperature of the plasma device reactor vessel is nearly 800° C.

According to any one of the above aspects, the apparatus, method and system may further comprise a process vessel that receives condensed product after cooling and condensing the product coming from a reactor.

According to any one of the above aspects, a spray chamber may be comprised for receiving cooled product. Lime solution may be fed into the spray chamber from a feeding port.

According to any one of the above aspects, a scrubber to neutralise the uncondensed acidic products may also be comprised. The scrubber may comprise a caustic and lime scrubber.

According to any one of the above aspects, a carbon bed to polish any trace gaseous product before releasing into the atmosphere may be comprised.

According to any one of the above aspects, the primary gas may comprise a condensable gas, for example steam, optionally, a high temperature superheated steam or optionally a mixture of high temperature steam and hydrogen peroxide. The steam may comprise pressurised hot water or steam at a temperature above 100; 105 or 110 deg C. and a pressure above 2; 4 or 6 bar. The temperature may comprise 120 deg C. and the pressure may comprise 8 bar. Advantageously, the primary gas not only acts as a heat carrier but also provides reactants to convert fluorine and chlorine radicals to stable reduced species such as, Hydrogen Fluoride and Hydrogen Chloride.

According to any one of the above aspects, the steam may be generated in a steam generator. The steam generator may comprise a boiler.

According to any one of the above aspects, a majority of the reaction products as well as the primary gas may be cooled and condensed back into liquid phase and collected in the process vessel.

According to any one of the above aspects uncondensed gaseous product from the process vessel may pass through a scrubber to neutralise the acidic gases. The neutralised solution may be collected in a process vessel. The scrubber may comprise a caustic and lime scrubber.

According to any one of the above aspects the primary gas, may be composed of oxidising reactants, reducing reactants or combination of both the oxidising and reducing reactants.

According to any one of the above aspects, a dual inlet system may be comprised. The primary gas may be injected via one or more primary gas injection port and the secondary gas may be injected via one or more secondary gas injection port. In one particular embodiment, the primary gas injection port may feed the primary gas on an angle or tangent into the plasma device. In another particular aspect, the secondary gas injection port may feed the secondary gas on an angle or a tangent into the plasma device. In another embodiment, the primary gas injection port may feed the primary gas on an angle or tangent into the plasma device and the secondary gas injection port may feed the secondary gas on an angle or a tangent into the plasma device.

According to any one of the above aspects, the primary gas may comprise water vapour.

According to any one of the above aspects, the secondary gas may comprise an inert gas or an oxidising gas. The inert gas may comprise argon. The oxidising gas may comprise oxygen or air. The secondary gas may comprise one or more of air; argon; or a mist of the one or more pollutant. In one particular aspect, the secondary gas comprises a mist of the one or more pollutant. When the secondary gas comprises a mist of the one or more pollutant no other gas may be required. When the secondary gas comprises air or argon the one or more pollutant may be injected into the secondary gas. The one or more pollutant may be dosed into a secondary gas line which injects the pollutant into the anode. The one or more pollutant may be provided as a liquid stream.

In one particular embodiment of any one of the above aspects, the one or more pollutant is partially vaporised to generate a pollutant vapour and a pollutant liquid mixture. The pollutant vapor is mixed with the primary gas and fed via the primary gas line. The pollutant liquid is fed into the secondary gas line. A flow control device may direct the pollutant vapor to the primary gas line and direct the pollutant liquid to the secondary gas line.

According to any one of the above aspects, a primary gas line for carrying the primary gas may be heated. According to any one of the above aspects, a secondary gas line for carrying the secondary gas may be heated. Both the primary gas line and secondary gas line may be heated.

According to any one of the above aspects, the secondary gas to liquid pollutant volume ratio may be from 1:1 to 25:1.

According to any one of the above aspects, the secondary gas may be injected using a flow control device. The flow control device may inject the one or more pollutant into the plasma device at a high swirl velocity.

According to any one of the above aspects, the injection of primary gas may be controlled by at least one of a valve and a flow meter.

According to any one of the above aspects, the one or more secondary gas injection port may comprise a header channel that is attached to the anode surface that channels the secondary gas into one or more tangential secondary gas injection ports housed around a circumference of the anode.

In another particular embodiment, the one or more secondary gas injection port may inject the secondary gas directly into the anode chamber.

According to any one of the above aspects, the one or more secondary gas injection port may comprise one or more tangential secondary gas injection port housed in the anode. The one or more tangential secondary gas injection port may be oriented in a co-current direction to that of the primary gas tangential swirl direction. Advantageously, this may augment the plasma gas swirl in the plasma device. The number of one or more tangential secondary gas injection ports may comprise between 2 and 12. The number of one or more tangential secondary gas injection ports may comprise 2; 3; 4; 5; 6; 7; 8; 9; 10; 11 or 12.

According to any one of the above aspects, the one or more tangential secondary gas injection port may be housed in the anode at an angle of 10 to 60 degrees from the radial plane. The one or more tangential secondary gas injection port may be oriented in a down-stream direction of plasma gas flow. In a particular embodiment the angle may be 15 degrees from the radial plane and in a down-stream direction. The angular injection of the secondary feed may minimise the impact of secondary feed dosing on the plasma gas swirl dynamics and may reduce the backpressure in the plasma torch due to introduction of secondary stream into the anode chamber.

According to any one of the above aspects, the secondary gas may be continuously fed into the plasma device via the secondary gas injection port.

According to any one of the above aspects, the secondary gas may help in increasing the injection tangential velocity of the one or more pollutant into an anode chamber.

According to any one of the above aspects, heat from an anode wall may be removed by circulating hot water at 120 deg C. on the external surface of the anode. This may ensure that inner surface skin temperature of the anode wall is above 120 deg C., thus to prevent any condensation of pollutant near the entrance mouth of the 2nd injection port.

According to any one of the above aspects, energy required to completely ionise the pollutant stream may be supplied by the plasma device, when the pollutant stream is mixed with the secondary gas. The ratio of plasma gas and the pollutant stream may be pre-determined to ensure that the pollutant stream is ionised completely.

According to any one of the above aspects, a typical mass ratio of pollutant stream (not considering the secondary gas) and the primary plasma gas steam (super-heated steam) may be between 1:3 and 1:1.

According to any one of the above aspects, a plasma power input may be set as per a primary gas stream flow rate to ensure complete ionization.

According to any one of the above aspects, a reactor may be a cylindrical vessel equipped with a converging nozzle at an inlet.

According to any one of the above aspects, an inner wall of the reactor may be lined with tungsten carbide.

According to any one of the above aspects, a reaction may take place at near ambient pressure, where the pressure is between 0-0.2 barg, or between 0.2 to 0.5 barg.

According to any one of the above aspects, a plasma plume temperature in an anode chamber may be greater than 3000° C.

According to any one of the above aspects, an average temperature in the reactor may be between 900 to 1200° C.

According to any one of the above aspects, one or more acidic gas such as hydrogen fluoride, hydrogen chloride, hydrogen peroxide may be produced. The one or more acidic gas may be neutralised by scrubbing with alkaline solution. The scrubber fluid may be collected in the process vessel along with the condensed reactor product.

According to any one of the above aspects, liquid from a process vessel may be recirculated back into the scrubber.

According to any one of the above aspects, the scrubber system may be equipped with a pH meter which is connected to a pH balance unit to maintain a pH of the process tank. The pH controls the metering of the pump that adds acid or base to maintain the pH of the process vessel to 10.0.

According to any one of the above aspects, gas escaping the scrubber may be fed into an activated carbon bed to adsorb any trace level residual acidic gases that may have accidently escaped the scrubber.

Further aspects and/or features of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1: is a schematic diagram showing one embodiment of an system assembly suitable for destruction of PFAS using plasma according to the invention.

FIG. 2: is a schematic diagram showing one embodiment of a plasma device according to the invention.

FIG. 3: is schematic diagram showing another embodiment of a plasma device according to the invention.

FIG. 3 is a schematic diagram showing an incline in a secondary inlet according to one embodiment of the invention.

FIG. 4: is another schematic diagram showing tangential entry into the anode chamber.

Skilled addressees will appreciate that elements in the drawings are illustrated for simplicity and clarity and have not necessarily been drawn to scale. For example, the relative dimensions of some elements in the drawings may be distorted to help improve understanding of embodiments of the present invention.

### DETAILED DESCRIPTION OF THE INVENTION

The present invention relates to a method, apparatus and system to break down the chemical waste fluoro-organic chemicals such as, PFAS (per fluoro alkyl substances) or mixture of PFAS with organic chemicals in a liquid mixture and to destroy all the chemicals and produce reaction end products that are non-toxic is described.

The invention relates to the destruction and mineralization of fluorinated hydrocarbons, mainly Perfluoroalkyl substances (PFAS) in waste water using a steam plasma system.

The first aspect of this invention resides in a new method or process for toxic waste destruction. In one embodiment, simultaneous chemical oxidation and reduction reaction takes places in a plasma device using superheated steam as the plasma gas. The superheated steam not only acts as the medium for carrying thermal energy from the electrical arc to the waste chemicals but also provides active radicals such as H⁺, OH⁻, O²⁻ etc. to facilitate the conversion of the toxic chemicals into benign end products.

The second and third aspects of this invention resides in a plasma device and plasma system comprising a pollutant feeding system whereby the pollutant is injected via one or more secondary gas injection port of the plasma device into the anode chamber where the one or more pollutant is contacted with the plasma arc and hottest plasma plume to reach temperatures greater than 2,000 deg C. to facilitate complete dissociation of the one or more pollutant without permitting any discharge of unreacted one or more pollutant form the plasma device.

In one embodiment, a plasma shield gas of argon is used to prevent the backflow of any waste from the secondary anode chamber and into the cathode. The flowrate of plasma shield gas is less than 5% of the total plasma carrier gas.

In another embodiment all the gaseous product generated in the plasma plume is effectively condensed in the quenching chamber and hence the process has a minimal gaseous emissions.

The present inventors have recognised that most of the thermal plasma processes for toxic chemical destruction are conducted in an oxygen environment (either rich or lean) to facilitate the destruction of the chemicals. Oxidising plasmas however are unsuitable for the destruction of fluorinated chemicals such as PFAS (perfluoro alkyl substances), as the reaction products that are formed can be harmful, including CxFx chemicals (mainly CF₄), and some fluorine gas, and potentially even fluorophosgene (COF₂). In the case of oxygen lean environment, the presence of hydrogen can facilitate some reduction of the species however, it can present difficulties associated with partial oxidation of organic chemicals that may also provide partial toxic intermediates.

The present investigators have also recognised that the use of air, nitrogen or argon in a plasma torch will result in some emission even when destroying liquid waste chemicals. The inefficiencies in mixing of waste chemical with plasma plume may result in trace amounts of toxic chemicals remaining partially destroyed or even untreated and depending on the partial pressure of the chemical in the gas phase, it may be released with the plasma gas emissions.

To overcome the issues associated with air or inert gas plasma system, the present inventors have developed a toxic waste device, method and system by replacing the conventional plasma gases with a steam plasma. The proposed system converts liquid water into a superheated steam that flows though the plasma arc to generate a steam plasma jet. Advantageously, and in contrast to conventional plasma gases such as, air and nitrogen, the application of steam plasma provides high partial pressure of oxygen and hydrogen species in the plasma plume that facilitates simultaneous oxidation and reduction reaction of the waste chemical (one or more pollutant) to produce CO₂ and H₂O from the oxidisable component and HF and HCl from the halogenated species. An additional benefit of the steam plasma may be that minimal emissions form the process as the excess steam is recondensed in the quenching unit after the reactor thus the total amount of gases being released is extremely small.

The present investigators have also recognised that mixing liquid pollutant into the plasma plume is non-ideal and as a result not all the pollutants are effectively broken down resulting in partial destruction. To overcome this issue, the present investigators have adopted a dual injection plasma device, whereby the plasma carrier gas, also referred to as the primary gas is injected via one or more primary injection port and the secondary gas, comprising the one or more pollutant, is injected via the one or more secondary injection port. The one or more pollutant is either directly fed into the secondary gas line or it is mixed with a gas which carries the one or more pollutant directly into the anode chamber where the arc strikes thus ensuring complete ionization.

The present invention relates to the destruction of PFAS and other fluorinated and chlorinated chemicals using a steam plasma reactor.

The present invention describes a process of oxidation and reducing reaction in a plasma zone to oxidise the hydrocarbons and reduce the halogenated species.

The reduced halogenated species transform to HF which can be neutralised in a lime solution to produce calcium fluoride. Similarly, any sulphur species present in the system can be converted to sulphuric acid and then neutralised in the lime solution to calcium sulphate.

The invention may utilise a DC thermal plasma torch to generate steam plasma by feeding superheated steam.

A thermal plasma may be formed via the application of an electric field of sufficient magnitude to a superheated steam, to induce molecule ionisation and electric conduction with the appearance of a gas discharge.

The thermal plasma may be characterised by a predominant thermodynamic equilibrium between the plasma species. The species produced in the steam plasma such as, H⁺, OH⁻, O²⁻ etc contribute to the reaction for destroying the toxic pollutants and converting it into harmless end products.

When the one or more pollutant, which may comprise fluorinated pollutants or a mixture of pollutants are fed into the plasma arc reactor, upon contact of the reactants with the high energy arc, the one or more pollutant molecules are rapidly dissociated. These dissociated species, then reacts with the plasma gas species to produce various reaction products and ionised molecules. As the dissociated and ionised molecules move away from the arc zone they recombine into various thermodynamically products.

From the teaching herein, the skilled person will be able to adapt the technique to control the recombination process, which may include controlling the rate of quenching and/or cooling of the product moving away from the arc zone, adjusting the reactant feed rate, the amount of energy fed to the arc process and others.

Typical chemical reactions occurring in the method when using PFOS pollutants as an example of the fluorinated pollutant source are:

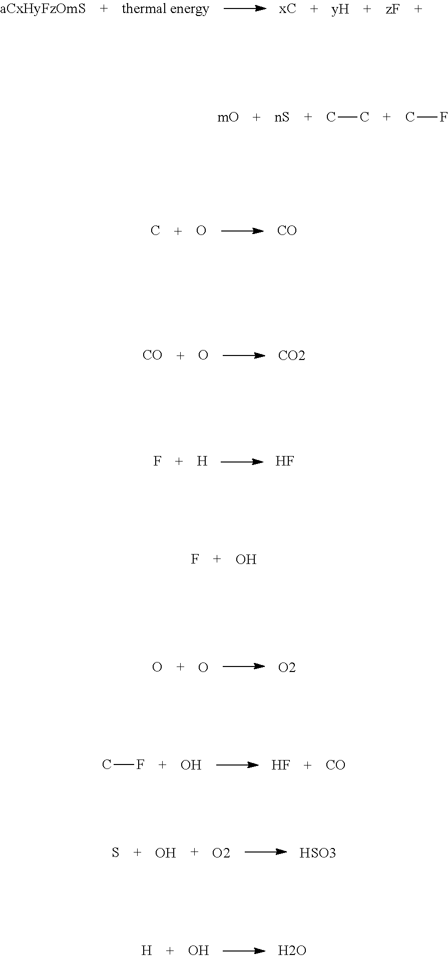

The above list presents a selection of the reactions which occur and does not represent the full list of reactions occurring in the plasma process.

A person of skill in the art is readily able to write analogous reactions for other fluorinated sources.

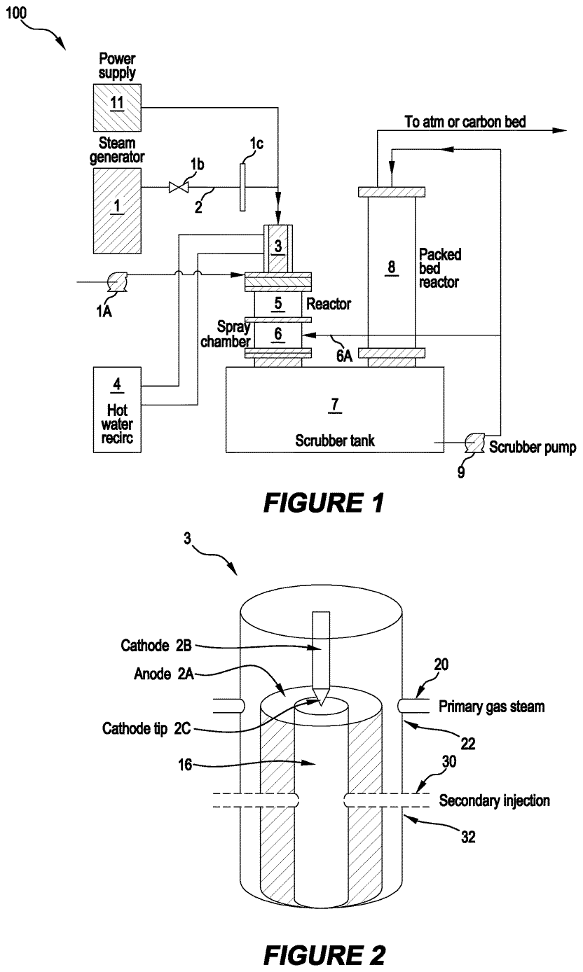

The steps and components in the present invention will now be described in detail. The process or method description is based on the drawing shown in FIG. 1, which shows one arrangement for plasma system 100 according to the present invention.

FIG. 1 shows system 100 in which superheated steam is generated in a steam generator 1, in the form of a boiler and fed via heated line 2 into the plasma device 3.

More detailed drawings of embodiments of a plasma device 3 according to the invention are shown in FIGS. 2, 3, 4 and 5.

The plasma arc 14 (not shown) is generated between the cathode 2B and anode 2A. Pressurised hot water at 120 deg C. and 8 bar is produced in hot water-recirculator 4 and circulated around an outer wall of the electrodes 2A, 2B to maintain the electrode surface temperature above 120 deg C.

A primary gas 24 (not shown) is provided through primary gas stream 20 (not shown) carried along primary gas line 26 and injected through one or more primary gas injection port 22. As shown in FIG. 1, the primary gas line 26 is heated and identified as heated line 2.

The plasma device 3 also comprises a secondary gas stream 30 (not shown), comprising secondary gas 34 (not shown), carried along secondary gas line 36 and injected through one or more secondary gas injection port 32, see FIG. 2. The secondary gas 34, primarily argon (or even air or oxygen) or mist of the one or more pollutant is fed via the secondary gas injection port 22 into the plasma. When the one or more pollutant is liquid it is dosed or injected in the secondary gas line 34 using the flow control device 1A which subsequently injects the pollutant into the plasma device 3 at high swirl velocity.

As shown in the Figures, the secondary gas 34 is fed directly into the anode chamber 16.

The amount of primary gas 24, in the form of steam, fed into the plasma device 3 is controlled by the use of valve 1B and the flow meter 1C.

The secondary gas 34, in the form of argon, is fed in the region adjacent the cathode 2B which acts as a shield gas to protect the cathode 2B from any accidental ingress of liquid water/pollutant from down-stream. Prior to starting the plasma device 3, superheated steam is fed into the plasma device 3 to equilibrate the temperature of the electrodes to 120 deg C.

The plasma device 3 comprises anode 2A and cathode 2B. The plasma arc 14 (not shown) is generated between the electrodes 2A, 2B due to the electrical potential applied from the plasma power supply 11 (not shown).

To ignite the plasma torch at the beginning of the process, a high-frequency starter is used to strike the first arc which breaks down the resistance between the electrodes 2A, 2B by ionising the steam flowing between them.

The high-temperature arc has a temperature of 10,000° C. or greater. This produces a bulk plasma plume temperature of 3000-4000° C. just at the tip of the anode 2A. The temperature drops rapidly as the plasma plume leaves the anode 2A and becomes 1600° C. within a small distance of 2 cm.

Since the PFAS pollutant molecules comprises of a very strong C—F bond, that requires a temperature in excess of 1600-1700° C. to dissociate hence it is imperative to feed the pollutant very close to the anode jet, or preferable in a dedicated chamber of the anode 2A.

The one or more pollutant fed into the anode 2A rapidly dissociates into the elemental form followed by reaction with the steam plasma species. The reaction mixture is then fed into the reactor 5, where the mixture is cooled before sending the mixture into a spray chamber 6 in which lime solution is fed through the feeding port 6A.

The reactor 5 is manufactured from a suitable material, for example stainless steel, and consist of a cylindrical pipe with a cooling water jacket surrounding the inner reaction zone.

The rapid quenching of the reaction mixture condenses a majority of the reaction mixture that falls into the reaction tank or scrubber tank 7 that contains 10% lime solution.

The remaining uncondensed gas is passed through a reactor tank 8, where all the acidic gas is neutralised into stable mineral. The neutralization reaction is as follows:

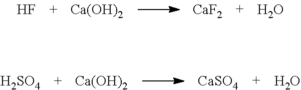

The operating pressure in the reactor tank 8 may be in the range of 1.1 barg to 2 barg. In the embodiment shown in FIG. 1, the reactor tank 8 is in the form of a prepacked bed reactor.

The scrubbed liquid is collected into the scrubber tank 7 and the solution from scrubber tank 7 is recirculated in to the reactor 8, via transfer pump 9.

The excess solution from the scrubber tank 7 is removed and could be discharged into any waste drainage line while the scrubber tank 7 is filled with fresh lime solution.

In another embodiment, the one or more pollutant is partially vaporised to generate a vapour and liquid mixture. The vapor is mixed with the steam from boiler 1 and fed via the heated line 2 (or secondary gas line 36). The liquid is fed into the one or more secondary port 32 using the flow control device 1A.

The plasma device 2 and system 100 may be modular. By modular is meant that various functional components are implemented in removal modules that when inserted into position provide certain functionality.

The apparatus 2 and system 100 may be mobile. By mobile is meant that it is capable of being transported or conveyed. The transportation or conveyance may be achieved by attaching the apparatus or system to a transport device such as a truck, train or ship.

So that the invention may be readily understood and put into practical effect, the following non-limiting examples are provided

### Example 1

The experimental setup for steam plasma device 2 and system 100 for PFAS destruction is similar to that shown in FIGS. 1 to 5. The system 100 includes a 25 kW thermal plasma torch 3 and associated electrical system, a superheated steam generator 1, a high pressure hot water recirculator 4, pollutant dosing unit 50, the reactor 8, spray chamber 6, the scrubber tank 7 and gas scrubbing pump 9.

The plasma device 1 is fed with 1 kg/hr of super-heated steam and 1 SLPM shield argon gas. The simulated PFAS solution was prepared by dissolving pure chemical in water. PFAS pollutant was fed at the rate of 10-20 ml/min. The pollutant as a single component of either PFOS, PFOA or PFBA in water. The heat from the plasma flame as dissipated inside the reactor walls which is removed from the cooling water running inside the reactor jacket.

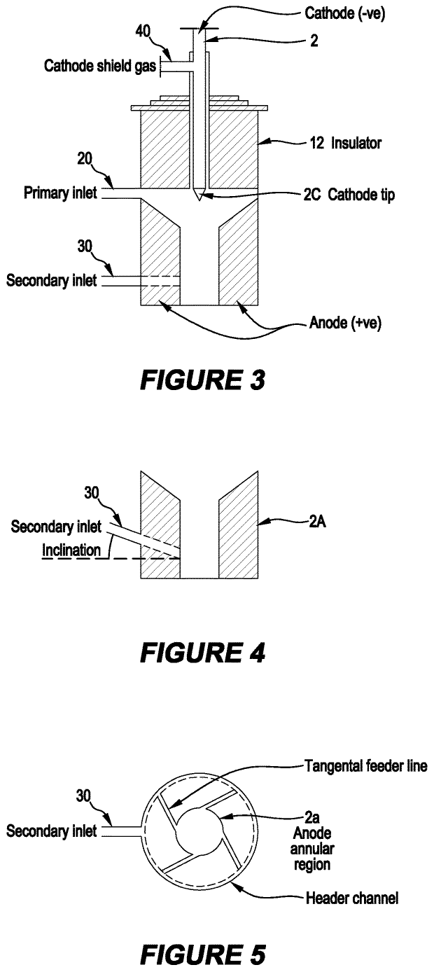

FIG. 3 illustrates another embodiment of a plasma device 2 according to the invention illustrating primary gas line 26 and secondary gas line 36 and insulation 12.

FIG. 4 shows another embodiment of an anode 2A illustrating that secondary gas injection inlet may comprise an incline. The angle of inclination may be between 10 degrees to 60 degrees.

FIG. 5 illustrates that secondary gas line may comprise via tangential entry into the anode chamber 16. The secondary gas line may comprise multiple secondary gas injection ports 32. While four ports 32 are illustrated, the may be between 2 and 12 ports.

The hydrogen fluoride gas produced during the process was captured by absorption in 20% caustic solution and the amount of sodium fluoride produced as measured to close the mass balance of fluorine and calculate the reaction efficiency. The results obtained are shown in Table 1 below:

TABLE 1

| | Pollutant | | | | | |
|---|---|---|---|---|---|---|
| | composition | | | | Pollutant | Fluorine |
| Steam | and | Pollutant | Plasma | Plasma | destruction | mineralization |
| flow | concentration | flow rate | Current | Power | % | % |
| SLPM | ppm | ml/min | A | kW | % | % |
| 16.6 | PFOS (2000 | 20 | 110 | 18 | 99.997 | 99.5 |
| | ppm) | | | | | |
| 16.6 | PFOA (500 | 15 | 100 | 15 | 99.99 | 99.35 |
| | ppm) | | | | | |
| 16.6 | PFBA (1000 | 15 | 100 | 15 | 99.99 | 99.6 |
| | ppm) | | | | | |

### Example 2

The destruction of concentrated aqueous film forming foam (AFFF) pollutant was carried out using the same procedure as in Example 1. The AFFF pollutant was fed at 15 ml/min and contained 30 different PFAS with several other chemicals. The results are shown in Table 2:

TABLE 2

| | Pollutant | | | | |
|---|---|---|---|---|---|
| | composition | | | | Pollutant |
| Steam | and | Pollutant | Plasma | Plasma | destruction |
| flow | concentration | flow rate | Current | Power | % |
| SLPM | ppm | ml/min | A | kW | % |
| 16.6 | AFFF 3% | 15 | 100 | 18 | 99.9 |

In this specification, the terms “comprises”, “comprising” or similar terms are intended to mean a non-exclusive inclusion, such that an apparatus that comprises a list of elements does not include those elements solely, but may well include other elements not listed.

Throughout the specification the aim has been to describe the invention without limiting the invention to any one embodiment or specific collection of features. Persons skilled in the relevant art may realize variations from the specific embodiments that will nonetheless fall within the scope of the invention.

1-15. (canceled)

16. A method for destruction of one or more pollutant, the method comprising:
creating an arc between a cathode and an anode with a dual feed plasma device, the dual feed comprising a primary gas and a secondary gas, the secondary gas comprising the one or more pollutant for destruction wherein the secondary gas is fed directly into an anode chamber.

17. A plasma device for destruction of one or more pollutant, the plasma device comprising:
a dual feed plasma device comprising a cathode and an anode, the dual feed comprising a primary gas and a secondary gas, the secondary gas being fed directly in an anode chamber and the secondary gas comprising the one or more pollutant for destruction.

18. A system for pollutant destruction comprising:
a primary gas line providing a primary gas;
a secondary gas line providing a secondary gas;
an anode chamber; and
a dual feed plasma device which creates an arc between a cathode and an anode, the dual feed comprising the primary gas and the secondary gas, the secondary gas comprising the one or more pollutant for destruction wherein the secondary gas is fed directly into the anode chamber.

19. The device according to claim 17, wherein a hot water recirculator provides high pressure hot water recirculation around the anode and optionally the cathode.

20. The device according to claim 17, wherein the one or more pollutant comprises waste fluoro-organic chemicals optionally PFAS.

21. The device according to claim 17, wherein the primary gas comprises a condensable gas, optionally steam, optionally, a high temperature superheated steam or optionally a mixture of high temperature steam and hydrogen peroxide.

22. The device according to claim 17, wherein the secondary gas comprises one or more of air, argon, or a mist of the one or more pollutant.

23. The device according to claim 17, comprising a dual inlet system.

24. The device according to claim 23, wherein the primary gas is injected via one or more primary gas injection port and the secondary gas is injected via one or more secondary gas injection port.

25. The device according to claim 24, wherein the primary gas injection port feeds the primary gas on an angle or tangent into the plasma device and/or the secondary gas injection port feeds the secondary gas on an angle or a tangent into the plasma device.

26. The device according to claim 17, wherein the secondary gas comprises an inert gas, an oxidising gas, or a mist of the one or more pollutant.

27. The device according to claim 17, wherein the one or more pollutant is partially vaporised to generate a pollutant vapour and a pollutant liquid mixture.

28. The device according to claim 17 wherein one or both of a primary gas line for carrying the primary gas and a secondary gas line for carrying the secondary gas is heated.

29. The device according to claim 17, wherein one or more secondary gas injection port injects the secondary gas directly into the anode chamber.

30. The device according to claim 17, wherein one or more secondary gas injection port comprises one or more tangential secondary gas injection port housed in the anode.

31. The device according to claim 30, wherein the one or more tangential secondary gas injection port is housed in the anode at an angle of 10 to 60 degrees from the radial plane.
